(19) United States
(12) Patent Application Publication
(10) Pub. No.: US 2006/0246166 A1
(43) Pub. Date: Nov. 2, 2006

(54) Injection molding system and method for using the same

(75) Inventors: Tung-Ming Hsu, Tu-Cheng (TW); Chin-Lung Wang, Tu-Cheng (TW); Chien-Min Chen, Tu-Cheng (TW); Yi-Sheng Feng, Shenzhen (CN); Jue-Hui Tian, Shenzhen (CN); Xia-Mei Zeng, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/413,894

(22) Filed: Apr. 28, 2006

(30) Foreign Application Priority Data
Apr. 28, 2005 (CN) 200510034476.8

(51) Int. Cl. B29C 45/78

(52) U.S. Cl. 425/143; 425/547

(57) ABSTRACT

An injection molding system (10) generally includes a molding device (100), a mold controller (200), and a negative pressure apparatus (300). The molding device defines a molding cavity (160) and a plurality of cooling channels (110) therein and has a plurality of heating elements (120). The heating elements are used for heating the molding cavity to a determined temperature. A cooling medium is supplied in the cooling channels to cool the molding cavity. The negative pressure apparatus is used for keeping the cooling channels in a negative pressure state, thereby improving the fluidity of the cooling medium during heat removal and avoiding leaving a portion of the cooling medium in the cooling channels during heating. Accordingly, the negative pressure apparatus can effectively decrease the heating and cooling terms/lengths. A method for using this system to manufacture a product made from a thermoplastic material is also provided.

### BACKGROUND

1. Technical Field

The invention relates generally to injection molding systems and, particularly, to an injection molding system with a rapid heating and cooling capability for manufacturing high quality components such as light guide plates. The invention also relates to a method for using such an injection molding system.

2. Discussion of Related Art

In an injection molding processes, particularly for a process suited for the molding of thermoplastic material, a mold temperature controller is an absolute necessity. Conventionally, the mold temperature controller relies upon water circulation. The mold temperature controller generally has a heating apparatus and a cooling apparatus. Before the molten thermoplastic material fills into a molding cavity of a molding device, the heating apparatus heats the water to a determined temperature. The hot water cycles in the molding cavity to heat the molding cavity, thereby keeping the molten thermoplastic material flowing. After the molten thermoplastic material fills into the molding cavity, the cooling apparatus cools the water. The cold water cycles in the molding device to cool the molding cavity, thereby forming the desired molded products.

The higher the temperature of the molding cavity is able to be during the filling of the molten thermoplastic material into the molding cavity, the better the fluidity of the thermoplastic material and, ultimately, the surface characteristics (e.g., smoothness) of the products are.

For high quality components used in the photoelectric field such as light guide plates, it is important that the components have good transparency and convertibility. Accordingly, it is important for the degree of surface smoothness thereof to be maximized, especially for non-diffuse surfaces. Thus, the temperature of the molding cavity of the molding device in the injection molding processes should be in the range from about 90° C. to about 200° C., to achieve sufficient flow. However, the highest temperature of the molding cavity of the molding device that the controller using water circulation can perform is less than 90° C., which cannot meet the temperature requirements for manufacturing the high quality components.

To settle this problem, another kind of mold temperature controller using oil circulation is utilized. In this kind controller, the oil is used to replace the water as a heating and cooling medium and a high temperature (i.e., more than 90° C.) of the molding cavity can be achieved. However, the thermal conduction coefficient of the oil is lower than that of water and the oil is a smeary material (i.e., does not flow as well as water, instead tending to leave a residue), thereby increasing the heating and cooling terms and decreasing productivity of the injection molding processes.

Recently, a mold temperature controller for heating and cooling a molding cavity of a molding device, combining steam and water, has been developed. In the heating process, the hot steam is filled into the molding device to heat the molding cavity to a temperature of more than 90° C. In the cooling process, the liquid medium is filled into the molding device to cool the molding cavity. In the next heating process, the liquid medium is firstly withdrawn and the hot steam is then filled. In the utilization of this controller, the heating process and the cooling process are provided to heat and cool the molding cavity, in turn, and an amount of leftover liquid medium is likely to remain in the molding device after cooling, so that the heating and cooling terms are increased. Furthermore, this controller is expensive and dangerous to operate in the heating process, thereby increasing the manufacturing cost.

What is needed, therefore, is an injection molding system with a rapid heating and cooling capability for manufacturing high quality components such as light guide plates.

What is also needed is a method for using such an injection molding system,

### SUMMARY

In one embodiment, an injection molding system is provided for manufacturing a product made from a thermoplastic material. The injection molding system generally includes a mold controller, a molding device, and a negative pressure apparatus. The molding device defines a molding cavity and a plurality of cooling channels therein and has a plurality of heating elements. Before the molten thermoplastic material fills into the molding cavity of the molding device, the heating elements are used for heating the molding cavity to a determined temperature to keep the thermoplastic material flowing. After the melt thermoplastic material fills into the molding cavity of the molding device, a cooling medium is cycled in the cooling channels to cool the molding cavity. The negative pressure is used for keeping the cooling channels in a negative pressure state, thereby improving the fluidity of the cooling medium. The improved flow helps improve the thermal conduction efficiency during cooling, reducing cooling times. Likewise, such flow helps to avoid having an amount of the cooling medium remain in the cooling channels during heating. Such a reduction in remnant cooling fluid, otherwise present during the heating cycle, helps decrease the heating terms (e.g., duration; energy input; etc.), as well.

A method, for using the above-mentioned injection molding system to make a product made from thermoplastic, includes a series of steps:
(a) assembling the cavity side mold and the core side mold by a closing process, thereby defining the molding cavity therebetween, the molding cavity being shaped according to the desired product features;
(b) heating the molding cavity by the heating elements to a determined temperature, the temperature being higher than a melting point of the thermoplastic material;
(c) filling the molten thermoplastic material into the molding cavity and heating the molten thermoplastic material by way of the heating elements;
(d) applying a cooling medium to cycle in the cooling channels of the molding device to cool the molding cavity to obtain the product, and starting the negative pressure apparatus to keep the cooling channels in the negative pressure state, and
(e) disassembling the cavity side mold and the core side mold by an opening process, and removing the product from the molding device.

Other advantages and novel features of the present injection molding system and method for using such will become more apparent from the following detailed description of preferred embodiments when taken in conjunction with the accompanying drawings.

### BRIEF DESCRIPTION OF THE DRAWINGS

Many aspects of the present injection molding system and method for using such can be better understood with reference to the following drawings. The components in the drawings are not necessarily to scale, the emphasis instead being placed upon clearly illustrating the principles of the present injection molding system and method for using such.

FIG. 1 is a schematic view of an injection molding system, in accordance with an exemplary embodiment of the present system;

FIG. 2 is a cross-section view of a molding device of the injection molding system of FIG. 1, showing the molding device as assembled;

FIG. 3 is a cross-section view of the molding device, showing molten thermoplastic material filled into a molding cavity of the molding device;

FIG. 4 is a cross-section view of the molding device, showing a formed product;

FIG. 5 is a cross-section view of the molding device, showing the molding device in a disassembled state;

FIG. 6 is a cross-section view of the molding device, showing the product ejected from the molding device; and

FIG. 7 is a coordinate graph, showing the temperature of molding cavity of the molding device in the utilization of the injection molding system.

Corresponding reference characters indicate corresponding parts throughout the several views. The exemplifications set out herein illustrate at least one preferred embodiment of the present injection molding system and method for using such, in one form, and such exemplifications are not to be construed as limiting the scope of the invention in any manner.

### DETAILED DESCRIPTION

Reference will now be made to the drawings to describe embodiments of the present injection molding system and method for using such, in detail.

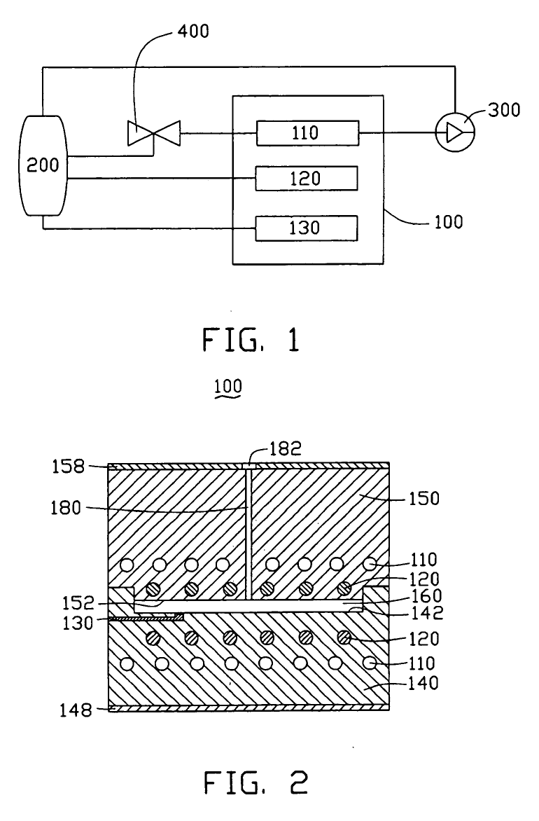

Referring to FIG. 1, an injection molding system 10, in accordance with an exemplary embodiment of the present system, is schematically shown. Generally, the injection molding system 10 includes a molding device 100, a mold controller 200, and a negative pressure apparatus 300 connected with the controller 200. The molding device 100 has a molding cavity 160 (FIG. 2) and a plurality of cooling channels 110 defined therein and has a plurality of heating elements 120. The molding cavity 160 is formed with a space shaped corresponding to a desired product and in which the molten thermoplastic material is cast.

The cooling channels 110 are utilized/configured for accommodating a cooling medium such as water or oil therein to cool the molding cavity 160 and for thus achieving a sufficient setting/hardening rate for the product formed using the molding device 100. Generally, the cooling channels 110 are defined in portions of the molding device 100 with a linear, parallel arrangement. Alternatively, a series of, e.g., zigzag or wave-shaped cooling channels (not shown) may be used instead of the illustrated arrangement of cooling channels 110.

The heating elements 120 are connected with and controlled by the controller 200. The heating elements 120 are embedded in portions of the molding device 100 near the molding cavity 160 to heating the molding cavity 160 and are configured for heating the thermoplastic material received in the molding cavity 160. The heating elements 120 are advantageously selected from an electrical resistance heating component and a high frequency induction heating component. The electrical resistance heating component preferably has a form selected from an electrical heating rod and an electrical heating plate. The high frequency induction heating component is beneficially a high frequency shock inductor.

The negative pressure apparatus 300 is connected with and controlled by the controller 200 and is in communication with the cooling channels 110. The negative pressure apparatus 300 is preferably selected from a negative pressure pump and a vacuum pump. During the cooling process, the negative pressure apparatus 300 is used for keeping the cooling channels 110 of the molding device 100 in a negative pressure state. Thus, the speed/flow of the cooling medium is improved, thereby aiding the cooling rate. Likewise, the opportunity for leftover/remnant cooling medium existing in the cooling channels 110 during heating is avoided/reduced, thereby ensuring an improved heating efficiency, relative to prior art systems, and thus a relatively short heating cycle.

The controller 200 is preferably selected from a programmable apparatus and a computer system. By means of determined programs, the controller 200 can control the heating of the heating elements 120; the supply of the cooling medium for the molding device 100; the molding device 100; and the negative pressure apparatus 300 automatically, thereby increasing the productivity of the injection molding system 10.

Preferably, a temperature sensor 130 is disposed near the molding cavity 160 of the molding device 100. The sensor 130 is connected with the controller 200. The function of the sensor 130 is for transmitting signals of the temperature of the molding cavity 160 to the controller 200, thus allowing the controller 200 to control the temperature of the molding cavity 160 precisely. The sensor 130 is preferably selected from a temperature wire (e.g., a thermocouple) and a temperature probe.

A valve 400 is preferably disposed in the injection molding system 10. The valve 400 is connected with and controlled by the controller 200. The valve 400 is disposed near the cooling channels 110 and is configured for controlling the cooling medium flow during cooling and for preventing the cooling medium from leaking into the cooling channels 110 during heating. It is to be understood that a plurality of valves 400 could be provided, especially if a larger molding device (e.g., a multi-product mold) is to be used.

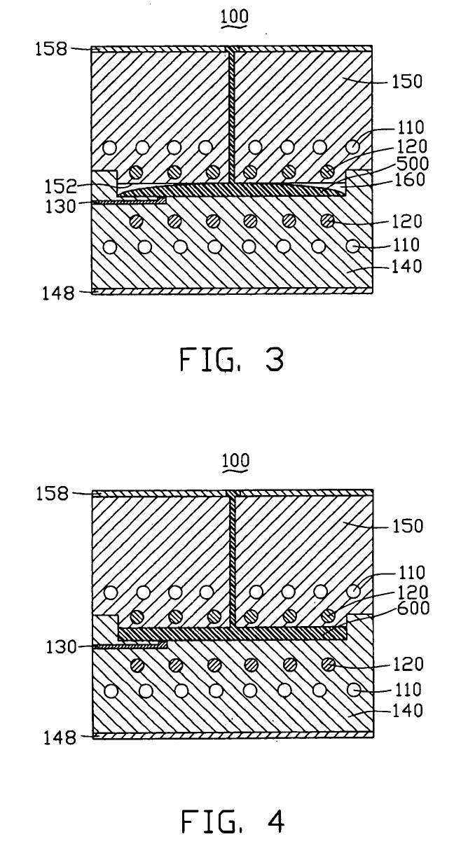

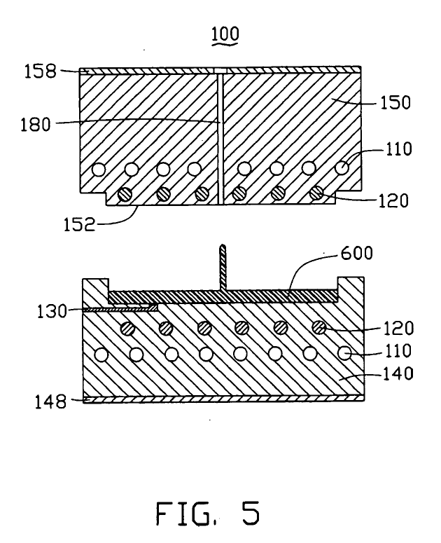

An example of the injection molding system 10, according to an preferred embodiment of the present system, is provided for describing the configuration thereof and method for using it to manufacture high quality productions, such as light guide plates, in detail, considering FIGS. 1-6 together. The injection molding system 10 has the molding device 100, the negative pressure apparatus 300 (e.g., a vacuum pump) and the controller 200 (e.g., a programmable apparatus). The vacuum pump is advantageously selected as the negative pressure apparatus 300. The programmable apparatus is opportunely chosen as the mold controller 200. The vacuum pump 300 and the molding device 100 are connected with and controlled by the programmable apparatus 200, respectively.

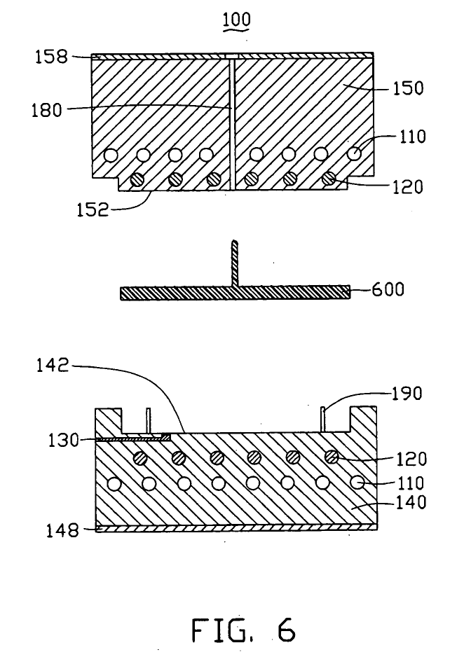

Referring to FIGS. 2 and 6, the cross-section views of the molding device 100 is shown. The molding device 100 includes a cavity side mold 140 and a core side mold 150. The molding cavity 160 is defined between the cavity side mold 140 and the core side mold 150. The molding cavity 160 is shaped as a rectangular shape corresponding to a desired product, such as a light guide plate (i.e., the cavity shape conforming to a desired product shape). A pair of cavity surfaces 142, 152 is formed on the cavity side mold 140 and the core side mold 150, respectively The cooling channels 110 are defined in each of the cavity side mold 140 and the core side mold 150. The cooling channels 110 are arranged in a parallel manner and communicate with the vacuum pump 300.

The heating elements 120 are advantageously in the form of a plurality of electrical heating rods and are embedded in each of the cavity side mold 140 and the core side mold 150, respectively. Preferably, a thermal conducting layer (not shown), such as a copper layer, is coated on each of the electrical heating rods 120 to increase the thermal conductivity thereof. The cooling channels 110 and the electrical heating rods 120 are arranged in lines, respectively. The individual electrical heating rods 120 are nearer to the molding cavity 160 than that the respective cooling channels 110. Two heat insulators 148, 158 are disposed on the cavity side mold 140 and the core side mold 150, respectively. The temperature sensor 130 is usefully in the form of a thermocouple, embedded in the cavity side mold 140, near the cavity surface 142 associated with the cavity side mold 140. A runner 180 is defined in the core side mold 150, perpendicular to and communicating with the molding cavity 160. The runner 180 forms a sprue gate 182 in a top portion of the core side mold 150. An ejector 190 is disposed on the cavity side mold 140.

In the above molding device 100, it is known that the arrangement of the cooling channels 110 and the electrical heating rods 120 may be altered. For example, the cooling channels 110 may be in a row that, instead, is nearer to the molding cavity 160 than a row formed by the electrical heating rods 120. The cooling channels 110 and the electrical heating rods 120 could be staggered within a row or several rows. Generally, it is to be understood that various configurations, individually and collectively, of the cooling channels 110 and/or the heating elements 120 are possible and are considered to be within the scope of the present system. In addition, the thermocouple 130 may be disposed in the core side mold 150, near the cavity surface 152 of the core side mold 150. The hot runner 180 may be defined in the cavity side mold 140 and/or inclined to the molding cavity 160.

A method uses the injection molding system 10 to manufacture a light guide plate 600. The light guide plate 600 is made from a thermoplastic material 500. The method generally includes a series of steps:
(a) assembling the cavity side mold 140 and the core side mold 150 by a closing process and using the heating elements 120 to heat the cavity surfaces 142, 152 to a determined temperature that is higher than the melting point of the thermoplastic material 500;
(b) filling the molten thermoplastic material 500 into the molding cavity 160 and keeping the cavity surfaces 142, 152 at the determined temperature;
(c) starting/activating the negative pressure apparatus 300 and applying the cooling medium, the cooling medium thereby filling into the cooling channels 110, the cooling channels 110 being kept in a negative pressure state, the cooled temperature of the cavity surfaces 142, 152 being lower than the melting point (advantageously lower than a setting/softening point) of the thermoplastic material 500 to obtain the light guide plate 600; and
(d) disassembling the cavity side mold 140 and the core side mold 150 by an opening process, removing the light guide plate 600 from the molding device 100 by, e.g., an ejecting process or a manual step, and excluding/evacuating any leftover amount of the cooling medium by the negative pressure apparatus 300.

In the step (a), the original temperature of the core side molds 140 and the cavity side mold 150 is about 30° C. Under the controlling of the programmable apparatus as the controller, the electric heating rods 120 are electrified in order to heat the cavity surfaces 142, 152 to the determined temperature. The temperature is determined by the melting point of the thermoplastic material 500. Generally, the thermoplastic material 500 is preferably selected from a polycarbonate (PC) material, such as mokrolon PC, LC1500, and polymethyl methacrylate (PMMA) material, such as MG5, MGSS. If the thermoplastic material 500 is MG5 that has a melting point of about 107° C., the determined temperature heated by the electrical heating rods 120 is preferably about 130° C. That is, the determined heating temperature is chosen so as to result in a viscosity of the thermoplastic material 500 that will facilitate fluid flow thereof.

In the step (b), when the temperature of the cavity surfaces 142, 152 is about 130° C., the temperature wire 130 transmits the signals to the programmable apparatus 200. Under the control of the programmable apparatus 200, the molten thermoplastic material 500 is filled into the molding cavity 160 via the sprue gate 182. The temperature of the cavity surfaces 142, 152 is kept at the temperature of about 130° C. by means of the electrical heating rods 120 being electrified intermittently, as needed to maintain the desired mold temperature.

In the step (c), after the molten thermoplastic material 500 is filled into the molding cavity 160, the valve 400 is opened and the vacuum pump 300 is started, both under the control of the programmable apparatus 200. Cooling water, being advantageously selected as the cooling medium, is applied to cycle in the cooling channels 110 of the molding device 100 to cool the cavity surfaces 142, 152, thereby forming the light guide plate 600. The vacuum pump 300 keeps the cooling channels 110 in the negative pressure state to improve the fluidity/flow rate of the water and to maximize the cooling rate.

In the step (d), when the temperature sensor 130 registers that the temperature of the cavity surfaces 142, 152 is about 30° C., the programmable apparatus 200 recognizes that the molding apparatus 100 has sufficiently cooled. Under the operation of the programmable apparatus 200, the valve 400 is closed to temporarily prevent further cooling water from entering the molding device 100. The core side mold 150 and the cavity side mold 140 are disassembled. The ejector 190 ejects the light guide plate 600 from the molding device 100. The vacuum pump 300 is used to help evacuate/remove the leftover water from/out of the cooling channels 110. It is to be understood that the ejector 190 may be eliminated in some designs (e.g., relying on manual removal of the finished product). Likewise, the cavity surfaces 142, 152 may be coated with a mold-release material, which would facilitate removal of the molded product upon its completion.

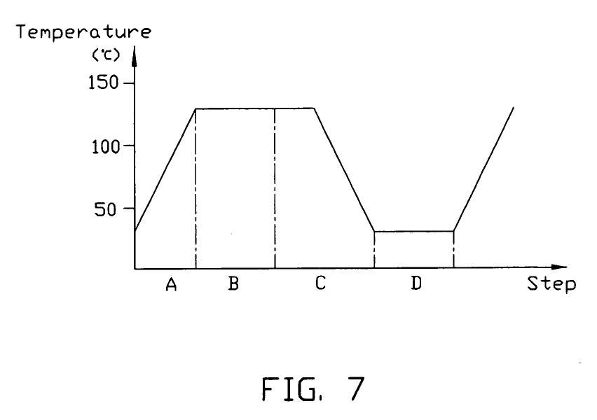

In the above-mentioned steps, the programmable apparatus 200 works automatically via one or more determined programs. The temperature of the cavity surfaces 142, 152 in the utilization of the injection molding system 10 in steps (a)-(d) is shown in FIG. 7. The variable associated with such steps, while not graphed per se, is time.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

We claim:

1. An injection molding system comprising:
a mold controller;
a molding device defining a molding cavity and at least one cooling channel therein, the molding device having a plurality of heating elements embedded therein near the molding cavity, the heating elements connected with and controlled by the controller, the heating elements thereby being configured for heating the molding cavity, the at least one cooling channel being configured for accommodating a cooling medium therein for cooling the molding cavity; and
a negative pressure apparatus connected with and controlled by the controller, the negative pressure apparatus being in communication with the at least one cooling channel for keeping the at least one cooling channel in a negative pressure state during the cooling process.

2. The injection molding system as claimed in claim 1, wherein the negative pressure apparatus is selected from a vacuum pump and a negative pump.

3. The injection molding system as claimed in claim 1, wherein each of the heating elements is selected from an electrical resistance heating component and a high frequency induction heating component.

4. The injection molding system as claimed in claim 3, wherein each heating element is an electrical resistance heating component, the electrical resistance heating component being selected from an electrical heating rod and an electrical heating plate.

5. The injection molding system as claimed in claim 3, wherein each heating element is a high frequency induction heating component, the high frequency induction heating component being a high frequency shock inductor.

6. The injection molding system as claimed in claim 1, further comprising a temperature sensor embedded in the molding device.

7. The injection molding system as claimed in claim 6, wherein the temperature sensor is selected from a thermocouple and a temperature probe.

8. The injection molding system as claimed in claim 1, further comprising a valve operatively associated with the at least one cooling channel of the molding device, the valve being connected with and controlled by the controller.

9. The injection molding system as claimed in claim 1, wherein the cooling medium is selected from water and oil.

10. The injection molding system as claimed in claim 1, wherein the controller is selected from a computer system and a programmable apparatus.

11. A method for using an injection molding system to manufacture a product made from a thermoplastic material, the injection molding system comprising a molding device and a negative pressure apparatus, the molding device comprising a core side mold and a cavity side mold each, respectively, with at least one cooling channel and a plurality of heating elements therein, the method comprising the steps of:
(a) assembling the cavity side mold and the core side mold by a closing process, thereby defining a molding cavity therebetween, the molding cavity conforming to a desired shape of the product;
(b) heating the heating elements to thereby bring the molding cavity to a determined temperature, the temperature being higher than a melting point of the thermoplastic material;
(c) filling the molten thermoplastic material into the molding cavity and heating the molten thermoplastic material using the heating elements;
(d) cycling a cooling medium into the at least one cooling channel of the molding device in order to cool the molding cavity and thus obtain the product in a solidified form, and activating the negative pressure apparatus to keep the at least one cooling channel in the negative pressure state while cycling the cooling medium; and
(e) disassembling the cavity side mold and the core side mold by an opening process, and removing the product from the molding device.

12. The method for using the injection molding system as claimed in claim 11, wherein a mold controller is used in the injection molding system to control the molding device, the negative pressure apparatus, the heating of the heating elements, and the supply of the cooling medium.

13. The method for using the injection molding system as claimed in claim 11, further comprising a step (f) of evacuating any leftover amount of the cooling medium by the negative pressure apparatus after the step (e).

14. The method for using the injection molding system as claimed in claim 11, wherein in the step (e), the light guide plate is removed from the molding device by an ejecting process or a manual step.
